(19) United States
(12) Patent Application Publication
(10) Pub. No.: US 2020/0056020 A1
(43) Pub. Date: Feb. 20, 2020

(54) WOOD PLASTIC COMPOSITE

(71) Applicant: Fiber Composites, LLC (dba Fiberon), New London, NC (US)

(72) Inventors: Christopher L. Ross, Albemarle, NC (US); Petros D. Kotiadis, Albemarle, NC (US)

(21) Appl. No.: 16/103,418

(22) Filed: Aug. 14, 2018

(51) Int. Cl. C08L 23/06; B32B 27/08; B32B 27/32; B32B 27/20; B29C 47/00; B29C 47/06

(52) U.S. Cl. CPC C08L 23/06; B32B 27/08; B32B 27/32; B32B 27/20; B29C 47/0004; B29K 2023/065; C08L 2205/025; C08L 2312/00; C08L 2207/062; B32B 2419/00; B29C 47/065

(57) ABSTRACT

A capstock may be composed of a bimodal olefin resin and an additive. The bimodal olefin resin may be composed of a first polymer having a first polymer percentage by weight based on a total weight of the bimodal olefin resin and a second polymer having a second polymer percentage by weight based on the total weight of the bimodal olefin resin. The capstock may have a thickness in the range of about 0.0015 in. to about 0.0030 in. The capstock may also include one or more fillers or additives. A building material may be composed of the capstock with a core, in which the capstock and core are co-fabricated. The capstock and core may be include polymer resins including LLDPE, LDPE, MDPE, HDPE, UHMWPE, a polyamide, PET, PP, or PVC.

### BACKGROUND

The building industry makes use of billions of dollars of building materials for fabricating structures intended for human use and habitation. Such structures are intended to last several decades before requiring replacement or repair. In some aspects, the building materials may be designed for use a part of exterior portions of such structures and must be able to withstand a wide variety of environmental conditions. Such environmental conditions may include, without limitation, temperature (for example from below −40° F. to above 120° F.), humidity (throughout the range of near 0% to about 100% relative humidity), sun exposure, and precipitation (including rain, snow, hail, wind, and wind-driven objects). Despite exposure to such environmental conditions, the building materials, especially their exterior surfaces, must retain their surface properties and not bleach, fade, crack, mar, or otherwise be degraded.

Several types of building materials are presently being used for exterior components of such structures. Such building materials may be composed of, without limitation, wood, plastics, and wood plastic composites (WPC). Each of these building materials has advantages and disadvantages which may include cost, ease of fabrication, surface degradation, and general maintainability.

In some aspects, it has been found that the application of a coating or surface layer over the building materials used as exterior components may improve their ability to withstand environmental conditions. The building material receiving the coating or surface layer may be referred to as a core material. Additional disadvantages, however, may arise depending on the type of coating or surface layer that is applied. In some examples, over time, the surface coating may delaminate from the underlying core material. In some examples, the surface layer may lack scratch resistance and be readily marred. In still other examples, the method of applying the surface layer may be expensive, process intensive, and may rely on materials that are difficult to store or transport to a fabrication site.

It is therefore desirable to develop a coating or surface layer material that can readily be applied to a core building material, and which is inexpensive, easily applied, and long lasting in the face of environmental conditions.

### SUMMARY

In an aspect, a capstock may include: a bimodal olefin resin composed of a first polymer having a first polymer percentage by weight based on a total weight of the bimodal olefin resin and a second polymer having a second polymer percentage by weight based on the total weight of the bimodal olefin resin. The capstock may further be composed of an additive, and have a thickness in the range of 0.0015 in. to 0.0030 in.

In one aspect of the capstock, the first polymer has a first density, the second polymer has a second density, and the first density is less than the second density.

In one aspect of the capstock, the first polymer is composed of a first comonomer, the second polymer is composed of a second comonomer, and the first comonomer differs from the second comonomer.

In one aspect of the capstock, the first polymer is composed of a comonomer, and the second polymer is a copolymer.

In one aspect of the capstock, the first polymer is composed of a high density polyethylene, and the second polymer is a polyethylene-hexene co-polymer.

In one aspect the capstock further includes the bimodal olefin resin having a first resin percentage by weight based on a total weight of the capstock, and the additive having an additive percentage by weight based on the total weight of the capstock.

In one aspect of the capstock, the first polymer includes any one of LLDPE, LDPE, MDPE, HDPE, UHMWPE, a polyamide, PET, PP, or PVC.

In one aspect of the capstock, the second polymer includes any one of LLDPE, LDPE, MDPE, HDPE, UHMWPE, a polyamide, PET, PP, or PVC, excluding a material comprising the first polymer.

In one aspect of the capstock, the additive includes one or more of mineral fillers, organic fillers, cellulosic materials, antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and pigments.

In an aspect, a material may include a capstock composed of a bimodal olefin resin including a first polymer having a first polymer percentage by weight based on a total weight of the bimodal olefin resin and a second polymer having a second polymer percentage by weight based on the total weight of the bimodal olefin resin. The capstock may also include an additive, and have a thickness in the range of 0.0015 in. to 0.0030 in. The material may also include a core, in which the capstock is co-fabricated with the core.

In one aspect of the material, the core includes any one or more of virgin resins, recycled resins, and a blend of virgin and recycled resins.

In one aspect of the material, one or more virgin resins, recycled resins, and blend of virgin and recycled resins includes any one or more of LLDPE, LDPE, MDPE, HDPE, UHMWPE, a polyamide, PET, PP, or PVC.

In one aspect of the material, the core further includes any one or more of mineral fillers, organic fillers, and conventional cellulosic materials.

In one aspect of the material, the core further includes any one or more of antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and/or pigments.

In one aspect of the material, the core further includes any one or more of a maleic anhydride, a silane grafted coupling agent, and a processing lubricant.

In one aspect of the material, the capstock and the core are co-extruded.

### BRIEF DESCRIPTION OF THE FIGURES

FIG. 1 depicts a plot of a bimodal olefin composition by molecular weight according to at least one aspect of the present disclosure.

FIG. 2 is a block diagram of a system for manufacturing a composition composed of a core material having a capstock layer according to at least one aspect of the present disclosure.

### DETAILED DESCRIPTION

As disclosed above, structural materials such as wood, plastic, and wood plastic composites (WPC) may be used to fabricate the exterior surfaces of structures. Such material may take the form of decking material, siding material, framing material (for windows or doors), trim, and other materials assembled as part of structures. It is useful for a manufacturer to create a single class of material that can withstand a wide variety of environmental conditions. It may be economically infeasible to create a variety of sets of materials, in which each material is designed to withstand only some subsets of environmental conditions. In general, wood, plastic, or WPC alone may generally not be able to withstand a variety of environmental conditions. As a result, the building materials may be fabricated to include one or more external layers or coatings (such as varnish) to protect the underlying core material. In some aspects, the external layers may be composed of a laminate applied to the surface of the structural material. However, such laminates are susceptible to delamination, peeling, and/or cracking over time (for example, due to differential thermal expansion of the core and the laminate). Thus, alternative manufacture has been considered for such exterior structural material.

One such alternative manufacture is to co-fabricate a core building material with a coating, typically referred to as a capstock.

The core building material may have any size or shape appropriate to its use including, without limitation, round stock, flat stock (such as decking or siding), casing, molding, trim, or any shaped building material. Examples of core building material may include, without limitation, virgin or recycled resins or a blend or blends thereof, and commingled recycled resins which can include, without limitation, linear low density polyethylene (LLDPE), low density polyethylene (LDPE), medium density polyethylene (MDPE), high density polyethylene (HDPE), ultra-high molecular weight polyethylene (UHMWPE), polyamides (such as nylon), polyethylene terephthalate (PET), polypropylene (PP) and polyvinyl chloride (PVC). The core building material may also contain organic and inorganic fillers. Non-limiting examples of fillers may include mineral and organic fillers (for example, talc, mica, clay, silica, alumina, carbon fiber, carbon black glass fiber) and conventional cellulosic materials (for example, wood flour, wood fibers, sawdust, wood shavings, newsprint, paper, flax, hemp, wheat straw, rice hulls, kenaf, jute, sisal, peanut shells, soy hulls, and/or other cellulose containing material). In addition, the core building material may include additives. Non-limiting examples of conventional additives may include antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and/or pigments. In some additional examples, the core may also contain a maleic anhydride or silane grafted coupling agent and a processing lubricant.

The core building material may contain about 5% to about 70% of a filler. Non-limiting examples of a percent composition of a filler of a core building material may include about 5%, about 10%, about 15%, about 20%, about 25%, about 30%, about 40%, about 50%, about 60%, about 70%, or a value or range of values therebetween, including endpoints. The core building material may also contain about 0.025% to about 5% of a coupling agent. Non-limiting examples of a percent composition of a coupling agent of a core building material may include about 0.025%, about 0.05%, about 0.1%, about 0.3%, about 0.5%, about 1%, about 3%, about 5%, or a value or range of values therebetween, including endpoints. Further, the core building material may also contain about 0.025% to about 5% lubricant. Non-limiting examples of a percent composition of a lubricant of a core building material may include about 0.025%, about 0.05%, about 0.1%, about 0.3%, about 0.5%, about 1%, about 3%, about 5%, or a value or range of values therebetween, including endpoints.

The capstock may conform to the outer shape of the core building material. In some non-limiting examples, the capstock may have a thickness that can range from about 0.0015 in. to about 0.0030 in. Non-limiting examples of a capstock thickness may include about 0.0015 in., about 0.0016 in., about 0.0017 in., about 0.0018 in., about 0.0019 in., about 0.0020 in., about 0.0021 in., about 0.0022 in., about 0.0023 in., about 0.0024 in., about 0.0025 in., about 0.0026 in., about 0.0027 in., about 0.0028 in., about 0.0029 in., about 0.0030 in., or a value or range of values therebetween, including endpoints.

In some examples, a capstock may be formed from a multilayered WPC material. Such multilayering may allow for a concentration of pigments, antioxidants, anti-UV additives, and other fillers to be located at or near the surface of the building material. Further, multilayering may allow for a more efficient use of antioxidants and reduce the product's moisture uptake in outdoor applications. However, multilayered WPC capstock scratches easily, and may crack due to the thermal expansion and contraction of the interior core building material during freeze/thaw cycles.

In another example, an ionomer may be included in an outer layer WPC capstock composition to improve scratch resistance and reduce capstock cracking and delamination when used in outdoor applications. However, after several years in the field, the ionomer may react adversely in extreme weathering conditions. Particularly, surface counter-ions (such as zinc) may draw water to the surface, leading to blooming and resultant discoloration of the exterior surface.

In still another example, crosslinkable silane grafted PE (PEX) may be used in the capstock layer to improve scratch resistance at higher temperatures. Additionally, the crosslinkable PE may also improve the capstock's adhesion to the WPC core. However difficulties may arise in the use of PEX during building material production. One disadvantage is that ungrafted PEX is moisture sensitive and requires specific containment and shipping conditions. Additionally, PEX requires a catalyst to effect the cross-linking, and the catalyst must be dried before extrusion combining with the uncrosslinked PEX. Further, the building material having a PEX capstock must be fully cured to produce the enhanced scratch and mar resistance. Complete cure of the building material under ambient conditions may take several weeks to assure completeness.

Disclosed herein is a capstock layer of a wood plastic composite, the composition of which contains a bimodal polyolefin resin which provides all of the advantages of crosslinkable polyethylene without the need for crosslinking the resin. The bimodal resin also eliminates the need to keep the resin dry before and during processing. Because the bimodal resin does not require cross-linking, its use also eliminates “scorch” or premature crosslinking during the extrusion process. The bimodal resin may be a composition formed by the combination of a lower molecular weight polymer and a higher molecular weight polymer. The higher molecular weight component of the bimodal resin may provide excellent scratch and mar resistance, while the lower molecular weight component of the resin may improve coextrusion of the capstock with the underlying building material core. Additional benefits of the bimodal polyolefin resin include a stable shelf life (compared to silane crosslinkable resin, which has a shelf life of approximately 6 months). The use of a bimodal resin also results in a significant cost advantage over that of a silane crosslinkable system. Cross-linked silane compositions require the cross-linking to occur at the time the capstock is manufactured. The catalyst for the silane crosslinked material, an organo-tin compound, also has adverse effects on the environment. Bimodal olefin-based capstocks to not require a catalytic step at the time of manufacture. In addition, the bimodal resin is recyclable. Once the PEX material is crosslinked, the material cannot be extruded again without the presence of un-melted polymer, which adversely affects production.

Bimodal polymer materials are composed of a mixture of two different polymers. The polymers may differ by molecular weight (for example average backbone length), density (related to the amount and degree of side chains to the backbone), composition (a single comonomer or one or more copolymers), or combination or combinations thereof. In some examples, a polymer may be chosen to have an average molecular weight in a range between about 85 Daltons to about 400 Daltons. In some alternative examples, a polymer may be chosen to have an average molecular weight in a range between about 400 Daltons to about 300 kilodaltons. Non-limiting examples of a polymer average molecular weight may include about 85 Daltons, about 90 Daltons, about 100 Daltons, about 200 Daltons, about 300 Daltons, about 400 Daltons, about 500 Daltons, about 1 kilodaltons, about 3 kilodaltons, 5 kilodaltons, about 10 kilodaltons, 30 kilodaltons, about 50 kilodaltons, 100 kilodaltons, about 300 kilodaltons, or a value or range of values therebetween, including endpoints. In some examples, a polymer may be chose to have a particular density. In some non-limiting examples, the polymer may have a density within a range of about 0.89 g/cm³ to about 0.96 g/cm³. Non-limiting examples of a polymer density may include about 0.89 g/cm³, about 0.90 g/cm³, about 0.91 g/cm³, about 0.92 g/cm³, about 0.93 g/cm³, about 0.94 g/cm³, about 0.95 g/cm³, about 0.96 g/cm³, or any value or range of values therebetween, including endpoints. In some examples, a polymer may be composed of a single comonomer such as ethylene or may be a copolymer (for example a copolymer of ethylene and hexene or ethylene and octene). In some examples, the bimodal polymer material may be composed of a first fraction of a high density polyethylene, and a second fraction of a polyethylene-hexene co-polymer.

In some aspects, a first polymer of a bimodal polymer material may include, without limitation, any one of linear low density polyethylene (LLDPE), low density polyethylene (LDPE), medium density polyethylene (MDPE), high density polyethylene (HDPE), ultra-high molecular weight polyethylene (UHMWPE), polyamides (such as nylon), polyethylene terephthalate (PET), polypropylene (PP) and polyvinyl chloride (PVC). In some aspects, a second polymer of a bimodal polymer material may include, without limitation, any one of linear low density polyethylene (LLDPE), low density polyethylene (LDPE), medium density polyethylene (MDPE), high density polyethylene (HDPE), ultra-high molecular weight polyethylene (UHMWPE), polyamides (such as nylon), polyethylene terephthalate (PET), polypropylene (PP) and polyvinyl chloride (PVC), with the restriction that the first polymer differs from the second polymer.

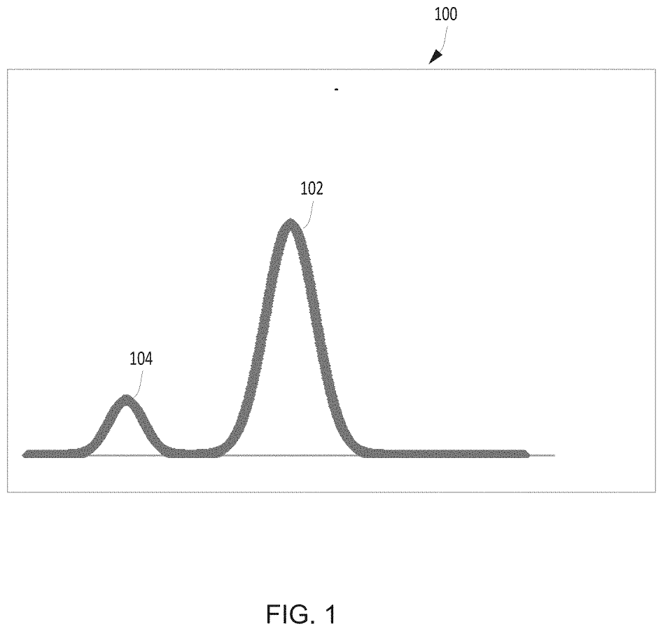

In some aspects, LLDPE may have a density in a range of about 0.915 g/cm³ to about 0.925 g/cm³. Non-limiting examples of a density of LLDPE may include about 0.915 g/cm³, about 0.916 g/cm³, about 0.917 g/cm³, about 0.918 g/cm³, about 0.919 g/cm³, about 0.920 g/cm³, about 0.921 g/cm³, about 0.922 g/cm³, about 0.923 g/cm³, about 0.924 g/cm³, about 0.925 g/cm³, or any value or range of values therebetween including endpoints. In some aspects, LDPE may have a density in a range of about 0.91 g/cm³ to about 0.92 g/cm³. In some aspects, HDPE may have a density in a range of about 0.93 g/cm³ to about 0.97 g/cm³. Non-limiting examples of a density of HDPE may include about 0.93 g/cm³, about 0.94 g/cm³, about 0.95 g/cm³, about 0.96 g/cm³, about 0.97 g/cm³, or any value or range of values therebetween including endpoints. FIG. 1 depicts a composition 100 of a bimodal polymeric material having a first fraction of a first polymer 102 having a first average molecular weight and a second fraction of a second polymer 104 having a second average molecular weight. Additional non-limiting descriptions of bimodal polyolefins and their compositions may be found in U.S. Pat. No. 7,250,473 entitled “Multimodal Polyolefin Pipe” to Schramm et al., filed Aug. 10, 2004, and issued Jul. 31, 2007, the disclosure of which is incorporated herein by reference in its entirety and for all purposes.

As depicted in FIG. 1, the first polymer 102 may have a higher average molecular weight than the second polymer 104. It may also be observed that the bimodal polymeric material has a larger polymer fraction by weight of the first polymer 102 than of the second polymer 104. It is understood that a bimodal polymer resin may include any relative fraction of a first polymer and any appropriate relative fraction of a second polymer to make up 100% by weight of the two polymers. It is further understood that each polymer may have any appropriate average molecular weight and appropriate variance in molecular weight depending on the polymer material and its method of manufacture. It may additionally be understood that the combination or combinations of polymers to compose the bimodal polymer material may be chosen based on the polymer average density as opposed to molecular weight, or according to any other physical characteristic of the polymers.

The bimodal resin for incorporation into the capstock can be prepared using any method usually employed in the plastics industry. In some non-limiting examples, the two components of the bimodal resin formulation may be blended together in a twin screw extruder, a Banbury mixer, or compounding mill. Thus, in some non-limiting examples, the bimodal resin may be compounded from the individual olefin materials at the time the capstock is fabricated. In some alternative examples, the bimodal resin may be purchased as a ready-made component to be incorporated into the capstock during fabrication. In some aspects, the ready-made bimodal olefin resin may be manufactured by a fabricator from the two polymers that may be combined by the sequential addition of the first polymer (for example, a low molecular weight polymer) to a reaction vessel synthesizing the second, high molecular weight polymer in a sequential fashion. In yet another aspect, the bimodal olefin resin may be fabricated from two polymers that may be synthesized together in a single reaction vessel containing two catalysts. In this aspect, the first catalyst may favor the formation of the first polymer and the second catalyst may favor the formation of the second polymer.

In some non-limiting examples, a bimodal polyolefin may be composed of about 30% HDPE and about 80% LLDPE. In some non-limiting examples, a bimodal polyolefin may be composed of about 95% HDPE and about 5% UHMWPE. In some non-limiting examples, a bimodal polyolefin may be composed of about 40% to about %60 high density polyethylene and about 60% to about 40% low density polyethylene. In general, the bimodal polyolefin may have a composition of a first component having a range of about 5% to about 95% by weight based on the total weight of the bimodal polyolefin material. Non-limiting examples of a percentage weight of the first component based on the total weight of the bimodal polyolefin material may include about 5% by weight, about 10% by weight, about 15% by weight, about 20% by weight, about 30% by weight, about 40% by weight, about 50% by weight, about 60% by weight, about 70% by weight, about 80% by weight, about 85% by weight, about 90% by weight, about 95% by weight, or any value or range of values therebetween including endpoints. Similarly, the bimodal polyolefin may have a composition of a second component having a range of about 95% to about 5% by weight based on the total weight of the bimodal polyolefin material. Non-limiting examples of a percentage weight of the second component based on the total weight of the bimodal polyolefin material may include about 95% by weight, about 90% by weight, about 85% by weight, about 80% by weight, about 70% by weight, about 60% by weight, about 50% by weight, about 40% by weight, about 30% by weight, about 20% by weight, about 15% by weight, about 10% by weight, about 5% by weight, or any value or range of values therebetween including endpoints.

The relative amounts and types of the two polymers combined to form the bimodal polymer material may be chosen based on the properties of each of the components. Thus, an amount of a low density polymer may be chosen to reduce the overall density of the bimodal polymer material and improve fabrication of the capstock. Alternatively, an amount of a high molecular weight polymer may be chosen to improve scratch resistance of the capstock and to reduce cracking due to unequal thermal expansion between the capstock and the building core material. Capstocks consisting of the disclosed bimodal polyolefin may exhibit the same advantages of crosslinked capstock without the processing steps required to cross-link the capstock polymer. The advantages may include, without limitation, superior scratch and mar resistance at elevated temperatures, reduced stress cracking due to thermal expansion, and superior flame retardancy.

The capstock may also include mineral and wood flour fillers as well as other additives. Non-limiting examples of fillers include mineral and organic fillers (for example, talc, mica, clay, silica, alumina, carbon fiber, carbon black glass fiber) and conventional cellulosic materials (for example, wood flour, wood fibers, sawdust, wood shavings, newsprint, paper, flax, hemp, wheat straw, rice hulls, kenaf, jute, sisal, peanut shells, soy hulls, and/or other cellulose containing material). Non-limiting examples of conventional additives may include antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and/or pigments.

Various combinations of bimodal olefin resins with fillers and additives may be contemplated as components of a capstock. In one non-limiting example, a capstock may be fabricated from a mixture of a portion of a bimodal polyethylene resin comprising HDPE, a portion of a pigment master-batch, a flame retardant, and an antioxidant master-batch. For example, the mixture may include a range of about 70% to about 98% HDPE, a range of about 0% to about 2.0% pigment master-batch, a range of about 0% to about 30% of a flame retardant, and a range of about 0% to about 2.0% of an antioxidant master batch. In one non-limiting example, the mixture may include about 70% HDPE, about 72% HDPE, about 74% HDPE, about 76% HDPE, about 78% HDPE, about 80% HDPE, about 84% HDPE, about 88% HDPE, about 90% HDPE, about 94% HDPE, about 98% HDPE, or any value or range of values therebetween, including endpoints. In one non-limiting example, the mixture may include about 0% pigment master-batch, about 0.2% pigment master-batch, about 0.4% pigment master-batch, about 0.6% pigment master-batch, about 0.8% pigment master-batch, about 1.0% pigment master-batch, about 1.2% pigment master-batch, about 1.4% pigment master-batch, about 1.6% pigment master-batch, about 1.8% pigment master-batch, about 2.0% pigment master-batch, or any value or range of values therebetween, including endpoints. In one non-limiting example, the mixture may include about 0% flame retardant, about 5% flame retardant, about 10% flame retardant, about 15% flame retardant, about 20% flame retardant, about 25% flame retardant, about 30% flame retardant, or any value or range of values therebetween, including endpoints. In one non-limiting example, the mixture may include about 0% antioxidant master-batch, about 0.2% antioxidant master-batch, about 0.4% antioxidant master-batch, about 0.6% antioxidant master-batch, about 0.8% antioxidant master-batch, about 1.0% antioxidant master-batch, about 1.2% antioxidant master-batch, about 1.4% antioxidant master-batch, about 1.6% antioxidant master-batch, about 1.8% antioxidant master-batch, about 2.0% antioxidant master-batch, or any value or range of values therebetween, including endpoints.

### EXAMPLE

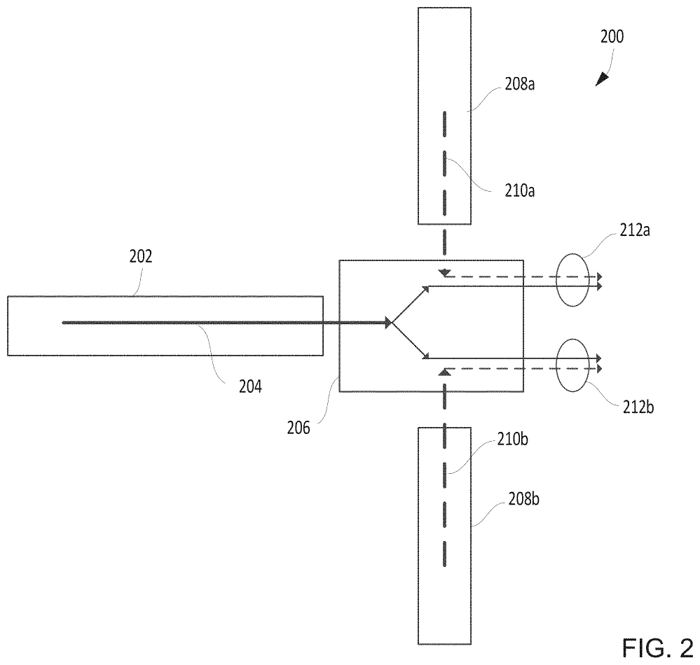

Samples of a core material including an external capstock layer were fabricated for the following tests. FIG. 2 illustrates a non-limiting system 200 for fabricating such samples. The system 200 includes a co-rotating twin screw extruder 202 that is used to blend the components of the core of the sample, and extrude the core material 204. The core material 204 included a mixture of wood flour and polyethylene blended together and extruded by the twin screw extruder 202. The co-rotating twin screw extruder 202 was configured to extrude the core material 204 into a first end of a Y-die block 206, in which the core material 204 diverged into two branches. Sample capstock material was fabricated from the bimodal olefin resins engineered for high temperature applications and composed of the materials disclosed below. The bimodal resins were melt blended with a mosaic pigment master batch at about a 2% loading in each of two 1 inch single screw extruders 208a,b to form the capstock extrudate 210a,b. Each single screw extruder 208a,b was connected to one of the branches of the y-die block 206. The capstock extrudate 210a,b entered each branch of the y-die block 206 and coated the core material 204 traveling therethrough. The capstock extrudate 210a,b adhered to the core material 204 inside of the y-die block 206 during extrusion. The samples, composed of the core material overlaid with the capstock, were extruded from the y-die block 206 as a pair of strands 212a,b. The capstock processing temperature within each single screw extruder 208a,b ranged from about 180° C. to about 200° C. over multiple temperatures zones. Each strand 212a,b of the extrudate was cooled in a water spray bath and cut to length. The strands 212a,b subjected to testing had a 1 in. by 5.5 in. core surrounded by a capstock having a thickness of about 0.0015 inches to about 0.0030 inches.

The sample olefin resins had compositions as follows:

Sample 1: Control HDPE

Sample 2: Bimodal polymer 25%/75% HDPE

Sample 3: Bimodal polymer 50%/50% HDPE

Sample 4: Bimodal Polymer 100%

Sample 5: PEX 10%/90% HDPE

Sample 6: PEX 15%/85% HDPE

Sample 7: PEX 25%/75% HDPE

### Experimental Results

Samples were placed in a hot water bath for one month. Table I displays the results of the amount of cracking observed in each sample over time (from 1 week through 4 weeks at weekly observations). Sample 1 (the control HDPE sample) displayed some hairline cracks at the beginning of week 4. Of the PEX samples, only Sample 7 (PEX 25%/75% HDPE) showed no cracking by week 4, while the remaining PEX samples (Samples 5 and 6) demonstrated cracking by week 2. All of the bimodal samples (Samples 2-4) did not demonstrate cracking for the duration of the test.

TABLE I

| Time vs. | | | | |
|---|---|---|---|---|
| Sample | | | | |
| Number | Week 1 | Week 2 | Week 3 | Week 4 |
| Sample 1 | No cracking | No cracking | No cracking | Hairline cracks |
| Sample 2 | No cracking | No cracking | No cracking | No cracking |
| Sample 3 | No cracking | No cracking | No cracking | No cracking |
| Sample 4 | No cracking | No cracking | No cracking | No cracking |
| Sample 5 | No cracking | Cracking | Cracking | Cracking |
| Sample 6 | No cracking | Cracking | Cracking | Cracking |
| Sample 7 | No cracking | No cracking | No cracking | No cracking |

Table II illustrates the scratch and mar performance of each capstock formula. The abrasion test measures the depth of the scratch at a given force. The abrasion test conformed to the ASTM D4060 test standard. Test results are calculated using the standard depth of wear calculation outlined in the ASTM standard. The lower numbers indicate better performance. The scratch test comprises dragging a pointed stylus across the surface of the sample at a constant force. The resulting scratch was measured spectrophotometrically in which L=100 represents the brightest possible reading and L=1 represents the darkest possible reading. The L value corresponds to the lightness axis of the CIELAB colorspace. The L values presented in Table II are the measurements made of the surface before and after the scratch test was performed. The greater the difference between the two numbers, the more visible the scratch. It can be observed in Table II that the bimodal resin capstock also performed as well as or better than the control HDPE capstock formula. In the abrasion and scratch tests depending on the loading used.

TABLE II

| | Abrasion Test | Scratch Test | |
|---|---|---|---|
| Sample Number | Test value | L = Before test | L = After test |
| Sample 1 | 7 | 36.03 | 37.58 |
| Sample 2 | 7 | 35.48 | 35.69 |
| Sample 3 | 6 | 38.39 | 38.78 |
| Sample 4 | 6 | 35.98 | 36.02 |
| Sample 7 | 7 | 35.88 | 37.5 |

While several aspects have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

It is worthy to note that any reference to “one aspect,” “an aspect,” “an example,” “one example,” and the like means that a particular feature, structure, or characteristic described in connection with the aspect is included in at least one aspect. Thus, appearances of the phrases “in one aspect,” “in an aspect,” “in an example,” and “in one example” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

Various aspects of the subject matter described herein are set out in the following numbered examples.

### Example 1

A capstock comprising:
a bimodal olefin resin comprising:
   a first polymer having a first polymer percentage by weight based on a total weight of the bimodal olefin resin; and
   a second polymer having a second polymer percentage by weight based on the total weight of the bimodal olefin resin; and an additive,
wherein the capstock has a thickness in the range of 0.0015 in. to 0.0030 in.

### Example 2

The capstock of Example 1, wherein the first polymer has a first density, the second polymer has a second density, and the first density is less than the second density.

### Example 3

The capstock of any one of Examples 1 through 2, wherein the first polymer comprises a first comonomer, the second polymer comprises a second comonomer, and the first comonomer differs from the second comonomer.

### Example 4

The capstock of any one of Examples 1 through 3, wherein the first polymer comprises a comonomer, and the second polymer is a copolymer.

### Example 5

The capstock of any one of Examples 1 through 4, wherein the first polymer comprises a high density polyethylene, and the second polymer is a polyethylene-hexene co-polymer.

### Example 6

The capstock of any one of Examples 1 through 5, further comprising:
the bimodal olefin resin having a first resin percentage by weight based on a total weight of the capstock; and
the additive having an additive percentage by weight based on the total weight of the capstock.

### Example 7

The capstock of any one of Examples 1 through 6, wherein the first polymer comprises any one of LLDPE, LDPE, MDPE, HDPE, UHMWPE, a polyamide, PET, PP, and PVC.

### Example 8

The capstock of Example 7, wherein the second polymer comprises any one of LLDPE, LDPE, MDPE, HDPE, UHMWPE, a polyamide, PET, PP, or PVC excluding a material comprising the first polymer.

### Example 9

The capstock of any one of Examples 1 through 8, wherein the additive comprises one or more of mineral fillers, organic fillers, cellulosic materials, antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and pigments.

### Example 10

A material comprising:
a capstock comprising:
   a bimodal olefin resin comprising:
      a first polymer having a first polymer percentage by weight based on a total weight of the bimodal olefin resin; and
      a second polymer having a second polymer percentage by weight based on the total weight of the bimodal olefin resin; and
   an additive,
   wherein the capstock has a thickness in the range of 0.0015 in. to 0.0030 in; and
a core,
wherein the capstock is co-fabricated with the core.

### Example 11

The material of Example 10, wherein the core comprises any one or more of virgin resins, recycled resins, and a blend of virgin and recycled resins.

### Example 12

The material of any one of Examples 10 through 11, wherein one or more virgin resins, recycled resins, blend of virgin and recycled resins comprises any one or more of LLDPE, LDPE, MDPE, HDPE, UHMWPE, a polyamide, PET, PP, and PVC.

### Example 13

The material of any one of Examples 10 through 12 wherein the core further comprises any one or more of mineral fillers, organic fillers, and conventional cellulosic materials.

### Example 14

The material any one of Examples 10 through 13, wherein the core further comprises any one or more of antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and pigments.

### Example 15

The material of any one of Examples 10 through 14, wherein the core further comprises any one or more of a maleic anhydride, a silane grafted coupling agent, and a processing lubricant.

### Example 16

The material of any one of Examples 10 through 15, wherein the capstock and the core are co-extruded.

We claim as follows:

1. A capstock comprising:
a bimodal olefin resin comprising:
a first polymer having a first polymer percentage by weight based on a total weight of the bimodal olefin resin; and
a second polymer having a second polymer percentage by weight based on the total weight of the bimodal olefin resin; and
an additive,
wherein the capstock has a thickness in the range of 0.0015 in. to 0.0030 in.

2. The capstock of claim 1, wherein the first polymer has a first density, the second polymer has a second density, and the first density is less than the second density.

3. The capstock of claim 1, wherein the first polymer comprises a first comonomer, the second polymer comprises a second comonomer, and the first comonomer differs from the second comonomer.

4. The capstock of claim 1, wherein the first polymer comprises a comonomer, and the second polymer is a copolymer.

5. The capstock of claim 1, wherein the first polymer comprises a high density polyethylene, and the second polymer is a polyethylene-hexene co-polymer.

6. The capstock of claim 1, further comprising:
the bimodal olefin resin having a first resin percentage by weight based on a total weight of the capstock; and
the additive having an additive percentage by weight based on the total weight of the capstock.

7. The capstock of claim 1, wherein the first polymer comprises any one of LLDPE, LDPE, MDPE, HDPE, UHMWPE, a polyamide, PET, PP, and PVC.

8. The capstock of claim 7, wherein the second polymer comprises any one of LLDPE, LDPE, MDPE, HDPE, UHMWPE, a polyamide, PET, PP, and PVC, excluding a material comprising the first polymer.

9. The capstock of claim 1, wherein the additive comprises one or more of mineral fillers, organic fillers, cellulosic materials, antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and pigments.

10. A material comprising:
a capstock comprising:
a bimodal olefin resin comprising:
a first polymer having a first polymer percentage by weight based on a total weight of the bimodal olefin resin; and
a second polymer having a second polymer percentage by weight based on the total weight of the bimodal olefin resin; and
an additive,
wherein the capstock has a thickness in the range of 0.0015 in. to 0.0030 in; and
a core,
wherein the capstock is co-fabricated with the core.

11. The material of claim 10, wherein the core comprises any one or more of virgin resins, recycled resins, and a blend of virgin and recycled resins.

12. The material of claim 11, wherein one or more virgin resins, recycled resins, blend of virgin and recycled resins comprises any one or more of LLDPE, LDPE, MDPE, HDPE, UHMWPE, a polyamide, PET, PP, and PVC.

13. The material of claim 10 wherein the core further comprises any one or more of mineral fillers, organic fillers, and conventional cellulosic materials.

14. The material of claim 10, wherein the core further comprises any one or more of antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and pigments.

15. The material of claim 10, wherein the core further comprises any one or more of a maleic anhydride, a silane grafted coupling agent, and a processing lubricant.

16. The material of claim 10, wherein the capstock and the core are co-extruded.
